(19) United States
(12) Patent Application Publication
(10) Pub. No.: US 2011/0102478 A1
(43) Pub. Date: May 5, 2011

(54) GAMMA ADJUSTMENT CIRCUIT AND METHOD AND DISPLAY DEVICE EMPLOYING SAME

(75) Inventors: SHUN-MING HUANG, Shenzhen (CN); XI-JIAN GUO, Shenzhen (CN)

(73) Assignees: INNOCOM TECHNOLOGY (SHENZHEN) CO., LTD., Shenzhen City (CN); CHIMEI INNOLUX CORPORATION, Miao-Li County (TW)

(21) Appl. No.: 12/898,674

(22) Filed: Oct. 5, 2010

(30) Foreign Application Priority Data
Oct. 30, 2009 (CN) 200910309108.8

(51) Int. Cl. G09G 5/10

(52) U.S. Cl. 345/690

(57) ABSTRACT

A display device includes a gamma adjustment circuit employing a method for adjusting red, green, blue (R, G, B) data of an image signal. The gamma adjustment circuit provides at least one look up table (LUT) to store gamma correction values, determines whether at least two kinds of color data from the R, G, B data require adjustment, searches for gamma correction values corresponding to the at least two kinds of color data from the R, G, B data requiring adjustment in the at least one LUT, and outputs the R, G, B data and the gamma correction values corresponding to the at least two kinds of color data from the R, G, B data requiring adjustment.

### BACKGROUND

1. Technical Field

The present disclosure generally relates to display devices, and particularly to a gamma adjustment circuit and method, and a display device using the same.

2. Description of Related Art

With widespread use of display devices, high display quality is increasingly prioritized. Accordingly, a gamma adjustment circuit for adjusting chroma of a display device has been developed and employed by the display devices.

A frequently used gamma adjustment circuit includes a control circuit, a first look up table (LUT) for storing gamma correction values corresponding to red image data (R data), a second LUT for storing gamma correction values corresponding to green image data (G data), and a third LUT for storing gamma correction values corresponding to blue image data (B data). The control circuit receives R, G, B data of an image signal, searches for corresponding gamma correction values respectively from the first, second and third LUTs according to the R, G, B data, and adjusts the R, G, B data.

However, some of the R, G, B data remains unchanged after adjustment in operation. That is, some image data requires no adjustment, or even unadjusted data has no effect on display quality of a display device. Therefore, the gamma adjustment circuit employing three LUTs results a waste of storage space.

What is needed, therefore, is a gamma adjustment circuit, a gamma adjustment method and a display device employing the same which can overcome the described limitations.

### SUMMARY

A gamma adjustment circuit for processing R, G, B data of an image signal includes at least one LUT to store gamma correction values, a determination circuit to determine whether at least two kinds of color data from the R, G, B data require adjustment, and a control circuit to search for gamma correction values corresponding to the at least two kinds of color data from the R, G, B data requiring adjustment in the at least one LUT and output the R, G, B data and the gamma correction values corresponding to the at least two kinds of color data from the R, G, B data requiring adjustment.

Other novel features and advantages will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout the several views, and all the views are schematic.

FIG. 1 is a schematic circuit block diagram of one embodiment of a gamma adjustment circuit, the gamma adjustment circuit including a first LUT.

FIG. 2 is a schematic diagram of one embodiment of the first LUT of FIG. 1.

FIG. 3 is a flowchart of one embodiment of a method for processing R data of an image signal by the gamma adjustment circuit of FIG. 1.

FIG. 4 is a flowchart of one embodiment of a method for processing G data of the image signal by the gamma adjustment circuit of FIG. 1.

FIG. 5 is a schematic circuit block diagram of another embodiment of a gamma adjustment circuit.

FIG. 6 is a schematic circuit block diagram of one embodiment of a display device.

### DETAILED DESCRIPTION

Reference will now be made to the drawings to describe various embodiments in detail.

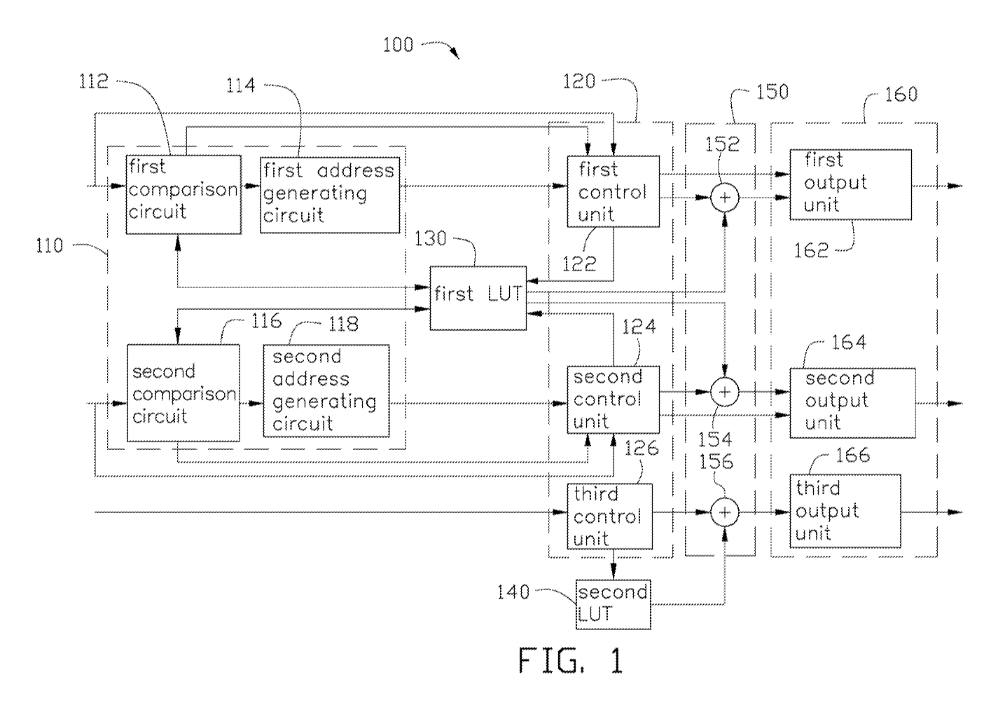

Referring to FIG. 1, a schematic circuit block diagram of one embodiment of a gamma adjustment circuit is shown. The gamma adjustment circuit 100 receives R, G, B data of an image signal, respectively processes the R, G, B data, and outputs an adjusted image signal. The gamma adjustment circuit 100 includes a determination circuit 110, a control circuit 120, a first LUT 130, a second LUT 140, a processing circuit 150, and an output circuit 160.

The determination circuit 110 receives the R data and the G data (or data of any other two colors) of the image signal, and determines whether the R data and the G data respectively require gamma correction according to corresponding gray levels of the R data and the G data. When any one or both of the R data and the G data require gamma correction, the determination circuit 110 outputs an address signal corresponding to the R data or the G data or outputs address signals respectively corresponding to the R data and the G data to the control circuit 120. When neither of the R data or the G data require gamma correction, the determination circuit 110 outputs an output signal corresponding to the R data or the G data or outputs output signals respectively corresponding to the R data and the G data to the control circuit 120. The determination circuit 110 includes a first comparison circuit 112, a second comparison circuit 116, a first address generating circuit 114, and a second address generating circuit 118. The first comparison circuit 112 and the first address generating circuit 114 process the R data, so as to output a first address signal or a first output signal corresponding to the R data, and the second comparison circuit 116 and the second address generating circuit 118 process the G data, so as to output a second address signal or a second output signal corresponding to the G data.

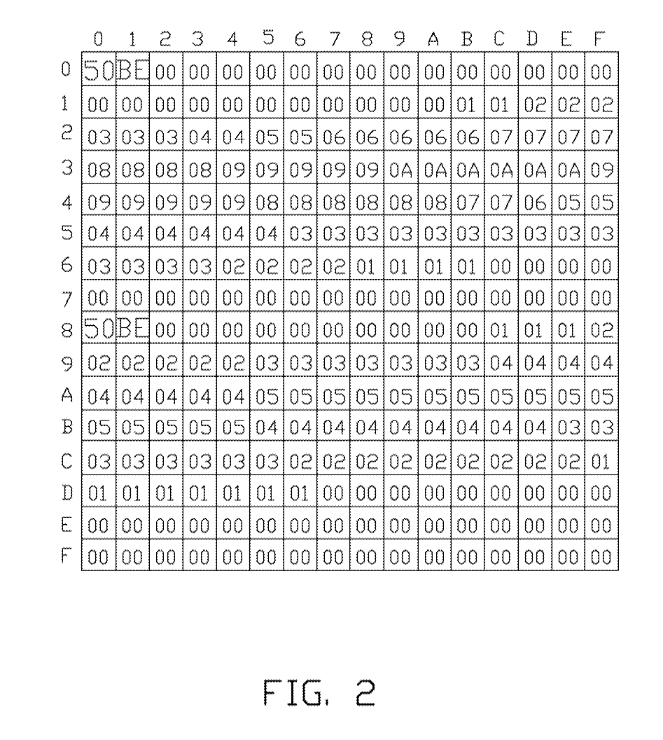

The first LUT 130 stores gamma correction values corresponding to part gray scales of the R data in a first predetermined range and part gray scales of the G data in a second predetermined range. That is, the gamma correction values stored in the first LUT 130 merely correspond to part gray scales of the R data and part gray scales of the G data. Referring to FIG. 2, a schematic diagram showing a relationship between the gamma correction values and the addresses respectively corresponding to the gamma correction values of the first LUT 130 is shown. The R data in the first predetermined range include a first starting gray scale and a first ending gray scale, and the G data in the second predetermined range include a second starting gray scale and a second ending gray scale. For example, the addresses 0X00 and 0X01 can respectively store the first starting gray scale and the first ending gray scale, and the addresses 8X00 and 8X01 can respectively store the second starting gray scale and the second ending gray scale. Thus, the addresses from 0X02 to 7XF respectively store the gamma correction values corresponding to the gray scales of the R data from the first starting gray scale to first ending gray scale, and the addresses from 8X02 to FXF respectively store the gamma correction values corresponding to the gray scales of the G data from the second starting gray scale to the second ending gray scale. When the gray scale of the R data received by determination circuit 110 is in the first predetermined range, the determination circuit 110 determines that the R data require gamma correction. When the gray scale of the G data received by determination circuit 110 is in the second predetermined range, the determination circuit 110 determines that the G data require gamma correction.

The second LUT 140 stores gamma correction values corresponding to all gray scales of the B data. That is, all the B data require gamma correction using the gamma correction values stored in the second LUT 140.

The control circuit 120 receives the R, G, B data, and the first and second address signals and the first and second output signals output by the determination circuit 110. The control circuit 120 searches for the gamma correction values corresponding to the R data or the G data requiring gamma correction in the first LUT 130 according to the first or second address signals, controls the first LUT 130 to output the gamma correction values corresponding to the R data or the G data requiring gamma correction to the processing circuit 150, and also outputs the R data or the G data requiring gamma correction to the processing circuit 150. In an alternative embodiment, the control circuit 120 can directly obtain the gamma correction values corresponding to the R data or the G data requiring gamma correction by searching in the first LUT 130 according to the first or second address signals and outputting the gamma correction values corresponding to the R data or the G data requiring gamma correction and the R data or the G data requiring gamma correction to the processing circuit 150. The control circuit 120 outputs the R data or the G data not requiring gamma correction according to the first or the second output signals to the output circuit 160. The control circuit 120 searches for the gamma correction values corresponding to the B data in the second LUT 140, directs the second LUT 140 to output the gamma correction values to the processing circuit 150, and also outputs the B data to the processing circuit 150. In an alternative embodiment, the control circuit 120 can directly obtain the gamma correction values corresponding to the B data by searching in the second LUT 140 and outputs the correction values and the B data to the processing circuit 150. The control circuit 120 includes a first control unit 122, a second control unit 124, and a third control unit 126 respectively corresponding to the R, G, B data. The first control unit 122 receives the R data, searches for the gamma correction value corresponding to the R data requiring gamma correction in the first LUT 130 according to the first address signal received from the first address generating circuit 114 of the determination circuit 110 and outputs the R data requiring gamma correction, or outputs the R data not requiring gamma correction according to the first output signal. The second control unit 124 receives the G data, searches for the gamma correction value corresponding to the G data requiring gamma correction in the first LUT 130 according to the second address signal received from the second address generating circuit 118 of the determination circuit 110 and outputs the G data requiring gamma correction, or outputs the G data not requiring gamma correction according to the second output signal. The third control unit 126 receives the B data, searches for the gamma correction value corresponding to the B data in the second LUT 140, and outputs the B data.

The processing circuit 150 receives the R, G data requiring gamma correction and the gamma correction values corresponding to the R, G data, and the B data and the gamma correction value corresponding to the B data, generates adjusted R, G, B data, and outputs the adjusted R, G, B data to the output circuit 160. The processing circuit 150 includes a first adder unit 152, a second adder unit 154, and a third adder unit 156. The first adder unit 152 adds the corresponding gamma correction value to the R data, and generates an adjusted R data. The second adder unit 154 adds the corresponding gamma correction value to the G data, and generates an adjusted G data. The third adder unit 156 adds the corresponding gamma correction value to the B data, and generates an adjusted B data.

The output circuit 160 outputs the adjusted R, G, B data and the R data or the G data not requiring gamma correction. The output circuit 160 includes a first output unit 162, a second output unit 164, and a third output unit 166. The first output unit 162 outputs the adjusted R data or the R data not requiring gamma correction, the second output unit 164 outputs the adjusted G data or the G data not requiring gamma correction, and the third output unit 166 outputs the adjusted B data.

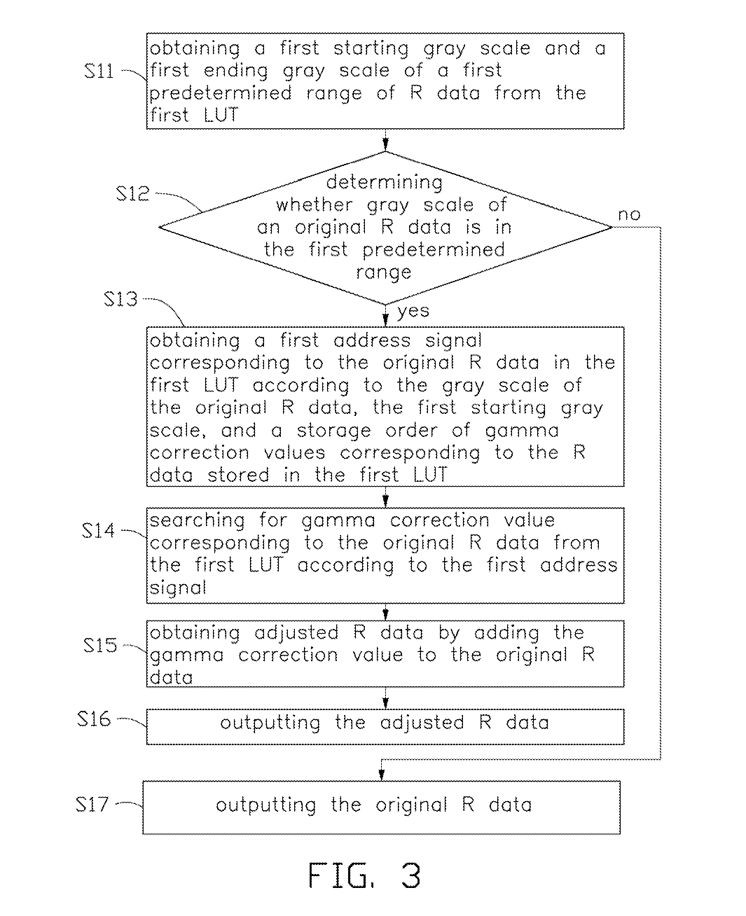

Referring to FIG. 3, a flowchart of a method for processing R data of an image signal by the gamma adjustment circuit 100 is shown, as follows.

In step S11 a first starting gray scale and a first ending gray scale of R data from the first LUT 130 are obtained. When the first comparison circuit 112 of the determination circuit 110 and the first control unit 122 of the control circuit 120 receive original R data of the image signal received by the gamma adjustment circuit 100, the first comparison circuit 112 reads the first starting gray scale and the first ending gray scale in the first predetermined range of the R data from the first LUT 130. For example, the first starting gray scale may be set to 80 gray scale and be stored at the address 0X00, and the first ending gray scale may be set to 205 gray scale and be stored at the address 0X01.

In step S12, the first comparison circuit 112 determines whether a gray scale of the original R data is in the first predetermined range which is from the first starting gray scale to the first ending gray scale. If so, step S13 is implemented. If not, step S17 is implemented.

In detail, the first comparison circuit 112 determines whether the gray scale of the original R data is in the first predetermined range. When the gray scale of the original R data is between the first staring gray scale and the first ending gray scale, the original R data requires adjustment. Thus, the first comparison circuit 112 outputs the gray scale of the original R data and the first starting gray scale to the first address generating circuit 114. When the gray scale of the original R data is less than the first staring gray scale and more than the first ending gray scale, the original R data requires not be adjusted. Thus, the first comparison circuit 112 outputs a first output signal to the first control unit 122, and the first control unit 122 outputs the original R data not being adjusted to the first output unit 162.

In step S13, a first address signal corresponding to the original R data in the first LUT 130 is obtained according to the original R data, the first starting gray scale, and a storage order of gamma correction values corresponding to the R data stored in the first LUT 130. When the addresses from 0X02 to 7XF successively store the gamma correction values corresponding to the gray scales of the R data between the first starting gray scale and the first ending gray scale, the first address generating circuit 114 generates the first address signal corresponding to the original R data by subtracting the first starting gray scale from the gray scale of the original R data and adding 1. For example, if the first starting gray scale and the first ending gray scale respectively equal 100 and 225, when the gray scale of the original R data is 120, because of the equation 120−100+1=21, the first address signal corresponding to the original R data is obtained to be 21.

In step S14, gamma correction value corresponding to the original R data is searched for from the first LUT 130 according to the first address signal. That is, the first address signal corresponding to the original R data is provided to the first control unit 122, and the first control unit 122 searches for the gamma correction value corresponding to the original R data from the first LUT 130 according to the first address signal. For example, if the first address signal corresponding to the original R data is 21 and the storage order of the first LUT 130 starts from 0, the 22^{nd} address 1X05 obtained by counting from the address 0X00 simply stores the gamma correction value corresponding to the original R data.

In step S15, obtaining adjusted R data is obtained by adding the gamma correction value to the original R data. The first control unit 122 outputs the gray scale of the original R data to the first adder unit 152. The first adder unit 152 receives the gray scale of the original R data and the gamma correction value corresponding to the original R data, adds the gamma correction value to the gray scale of the original R data to obtain the adjusted R data, and outputs the adjusted R data to the first output unit 162.

In step S16, the adjusted R data is output. The first output unit 162 receives and outputs the adjusted R from the first adder unit 152.

In step S17, the original R data is output. The first output unit 162 receives and outputs the original R data not being adjusted from the first control unit 122.

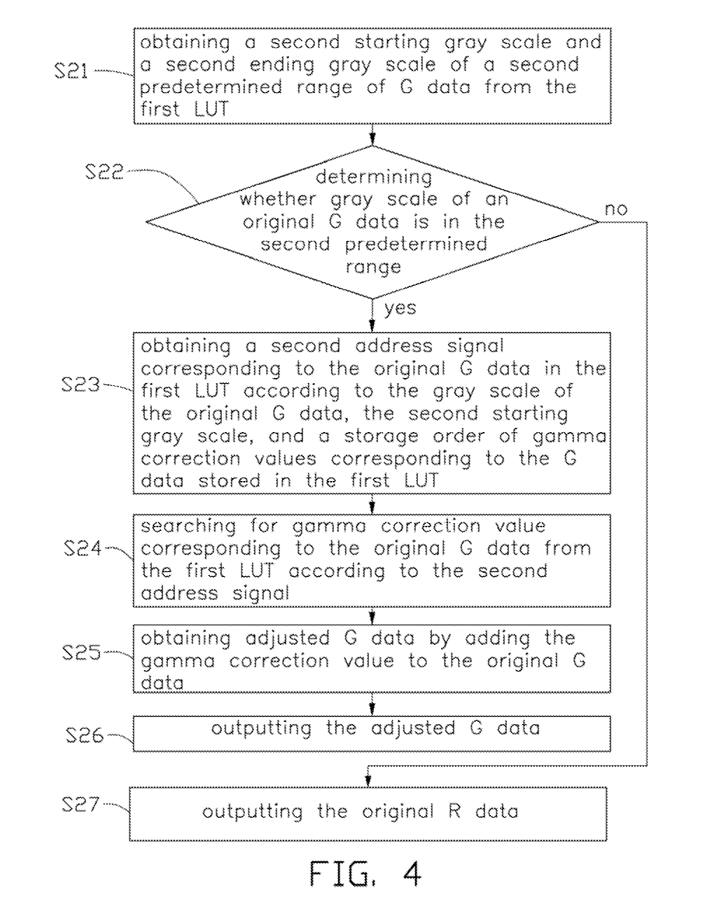

Referring to FIG. 4, a flowchart of a method for processing G data of an image signal by the gamma adjustment circuit 100 is shown. The method is similar to the method for processing the R data, as follows.

In step S21, a second starting gray scale and a second ending gray scale of the second predetermined range of G data from the first LUT 130 are obtained. When the second comparison circuit 116 of the determination circuit 110 and the second control unit 124 of the control circuit 120 receive an original G data of the image signal received by the gamma adjustment circuit 100, the second comparison circuit 116 reads the second starting gray scale and the second ending gray scale of the second predetermined range of the G data from the first LUT 130. For example, the second starting gray scale may be stored at the address 8X00, and the second ending gray scale may be stored at the address 8X01.

In step S22, the second comparison circuit 116 determines whether a gray scale of the original G data is in the second predetermined range which is from the second starting gray scale to the second ending gray scale. If so, step S23 is implemented. If not, step S27 is implemented.

In detail, the second comparison circuit 116 determines whether the gray scale of the original G data is in the second predetermined range. When the gray scale of the original G data is between the second staring gray scale and the second ending gray scale, the original G data requires adjustment. Thus, the second comparison circuit 116 outputs the gray scale of the original G data and the second starting gray scale to the second address generating circuit 118. When the gray scale of the original G data is less than the second staring gray scale and more than the second ending gray scale, the original G data requires no adjustment. Thus, the second comparison circuit 116 outputs a second output signal to the second control unit 124, and the second control unit 124 outputs the original G data not being adjusted to the second output unit 164.

In step S23, a second address signal corresponding to the original G data in the first LUT 130 is obtained according to the original G data, the second starting gray scale, and a storage order of gamma correction values corresponding to the G data stored in the first LUT 130. When the addresses from 8X02 to FXF successively store the gamma correction values corresponding to the gray scales of the G data between the second starting gray scale and the second ending gray scale, the second address generating circuit 118 generates the second address signal corresponding to the original G data by subtracting the second starting gray scale from the gray scale of the original G data and adding 129. For example, if the second starting gray scale and the second ending gray scale respectively equal 100 and 225, when the gray scale of the original G data is 120, because of the equation 120−100+129=149, the second address signal corresponding to the original G data is obtained to be 149.

In step S24, gamma correction value corresponding to the original G data is searched for from the first LUT 130 according to the second address signal. That is, the second address signal corresponding to the original G data is provided to the second control unit 124, and the second control unit 124 searches for the gamma correction value corresponding to the original G data from the first LUT 130 according to the second address signal. For example, if the second address signal corresponding to the original R data is 149, the 150^{th} address 9X05 obtained by counting from the address 0X00 just stores the gamma correction value corresponding to the original G data.

In step S25, adjusted G data is obtained by adding the gamma correction value to the original G data. The second control unit 124 outputs the gray scale of the original G data to the second adder unit 154. The second adder unit 154 receives the gray scale of the original G data and the gamma correction value corresponding to the original G data, adds the gamma correction value to the gray scale of the original G data to obtain the adjusted G data, and outputs the adjusted G data to the second output unit 164.

In step S26, the adjusted G data is output. The second output unit 164 receives and outputs the adjusted G from the second adder unit 154.

In step S27, the original G data is output. The second output unit 164 receives and outputs the original G data not being adjusted from the second control unit 124.

Referring to FIG. 1 again, a method for processing B data of an image signal by the gamma adjustment circuit 100 includes: providing an original B data to the third control unit 126, obtaining a gamma correction value corresponding to the original B data from the second LUT 140 by the third control unit 126 according to gray scale of the original B data, providing the gamma correction value corresponding to the original B data and the gray scale of the original B data to the third adder unit 156, obtaining adjusted B data by adding the gamma correction value to the gray scale of the original B data via the third adder unit 156, providing the adjusted B data to the third output unit 166, and outputting the adjusted B data by the third output unit 166.

It should be noted that the original R, G, B data received by the gamma adjustment circuit 100 is usually 8-bit data. However, 10-bit data output by the gamma adjustment circuit 100 may be required in actual application. Thus, the control circuit 120 is required to transform the 8-bit data to the 10-bit data, and outputs the 10-bit data. The control circuit 120 can transform the 8-bit data to the 10-bit data by left shifting the 8-bit data by 2 bits. For example, 8-bit data of the gray scale of the original R data of 11111111, after being processed by the first control unit 122 becomes 10-bit data of 1111111100. Similarly, the second control unit 124 can also transform 8-bit data of gray scale of the original G data to 10-bit data, and provide the 10-bit data to the second adder unit 154 or the second output unit 164. The third control unit 126 can also transform 8-bit data of gray scale of the original B data to 10-bit data, and provide the 10-bit data to the third adder unit 156.

The gamma adjustment circuit 100 employs the first LUT 130 to merely store gamma correction values corresponding to part gray scales of the R, G data, employs the determination circuit 110 to determine whether the gray scales of the original R, G data require adjustment, and employs the control circuit 120 to search for gamma correction values corresponding to the original R, G data requiring adjustment in the first LUT 130 and directly outputting the original R, G data not being adjusted. Thus, the gamma adjustment circuit 100 merely requires a first LUT 130 for processing the R, G data, and saves storage space.

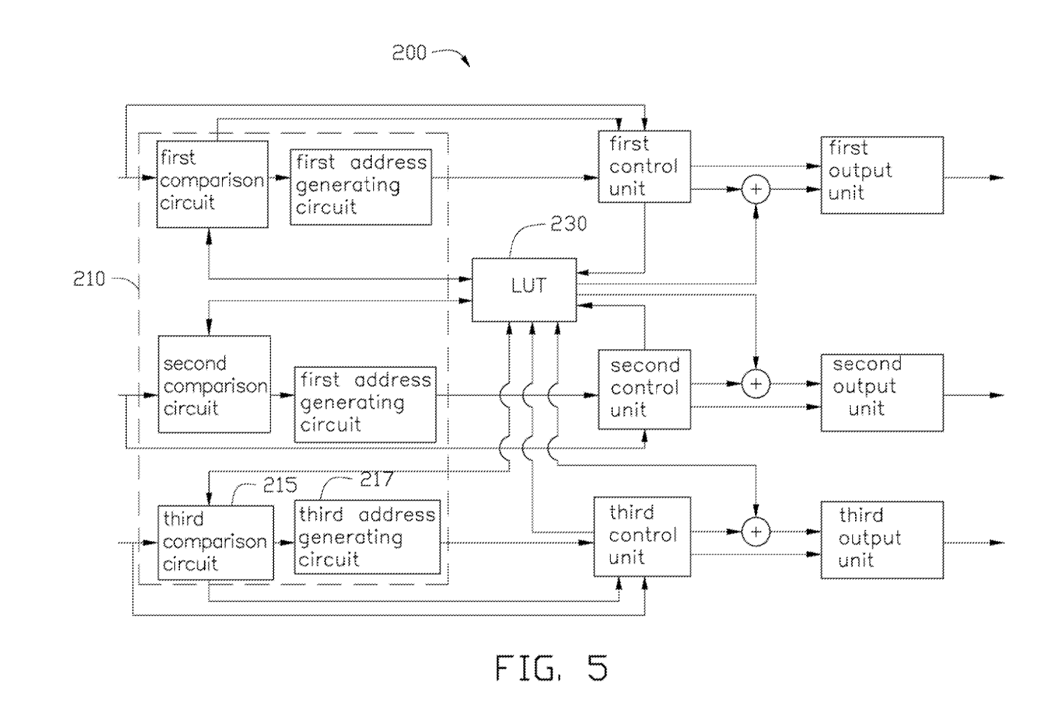

Referring to FIG. 5, a schematic circuit block diagram of another embodiment of a gamma adjustment circuit is shown. The gamma adjustment circuit 200 is similar to the gamma adjustment circuit 100, however, the gamma adjustment circuit 200 merely includes one LUT 230, and further includes a third comparison circuit 215 and a third address generating circuit 217. The LUT 230 stores gamma correction values corresponding to part gray scales of the R, G, B data. A method for processing B data of an image signal by the gamma adjustment circuit 200 is similar to that processing the R, G data by the gamma adjustment circuit 100. The method for processing the B data by the gamma adjustment circuit 200 is as follows.

A third starting gray scale and a third ending gray scale of a third predetermined range of B data from the LUT 230 are obtained.

The third comparison circuit 215 determines whether gray scale of an original B data is in the third predetermined range. If so, the subsequent step is implemented. If not, outputting the original B data.

An address signal corresponding to the original B data in the LUT 230 is obtained according to the original B data, the third starting gray scale, and a storage order of gamma correction values corresponding to the B data stored in the LUT 230.

A gamma correction value corresponding to the original B data is searches for from the LUT 230 according to the address signal.

Adjusted B data is obtained by adding the gamma correction value to the original B data.

The adjusted B data is output.

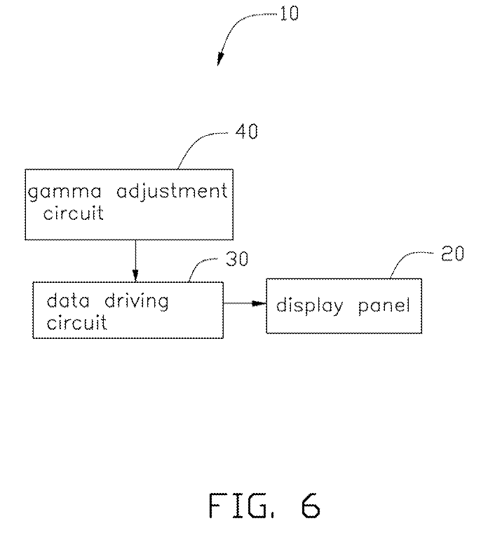

Referring to FIG. 6, a schematic circuit block diagram of one embodiment of a display device is shown. The display device 10 includes a gamma adjustment circuit 40, a data driving circuit 30, and a display panel 20. The gamma adjustment circuit 40 receives R, G, B data of an image signal, processes the R, G, B data to obtain adjusted R, G, B data, and provides the adjusted R, G, B data to the data driving circuit 30. The data driving circuit 30 generates display driving signals according to the adjusted R, G, B data, and provides the display driving signals to the display panel 20. The display panel 20 displays the image according to the display driving signals. The display panel 20 may be a liquid crystal display panel. The gamma adjustment circuit 40 can be the gamma adjustment circuit 100 or the gamma adjustment circuit 200. Thus, the display device 10 can accordingly conserve storage space.

It is believed that the present embodiments and their advantages will be understood from the foregoing description, and it will be apparent that various changes may be made thereto without departing from the spirit and scope of the embodiments or sacrificing all of their material advantages.

What is claimed is:

1. A gamma adjustment circuit for processing red, green, blue (R, G, B) data of an image signal, the circuit comprising:
at least one look up table (LUT) to store gamma correction values;
a determination circuit to determine whether at least two kinds of color data from the R, G, B data require adjustment; and
a control circuit to search for gamma correction values corresponding to the at least two kinds of color data from the R, G, B data requiring adjustment in the at least one LUT and output the R, G, B data and the gamma correction values corresponding to the at least two kinds of color data from the R, G, B data requiring adjustment.

2. The gamma adjustment circuit of claim 1, wherein the at least one LUT stores the gamma correction values corresponding to part of gray scales of the at least two kinds of color data from the R, G, B data respectively in predetermined ranges, each predetermined range corresponding to one color data.

3. The gamma adjustment circuit of claim 2, wherein the determination circuit receives original R, G, B data and determines whether gray scales of at least two kinds of color data from the original R, G, B data are in the predetermined ranges, when the gray scales of the at least two kinds of color data from the original R, G, B data are in the predetermined ranges, the at least two kinds of color data from the original R, G, B data requiring adjustment, and the determination circuit outputting corresponding address signals to the control circuit, and when the gray scales of the at least two kinds of color data from the original R, G, B data are out of the predetermined ranges, the determination circuit outputting corresponding output signals to the control circuit to output the at least two kinds of color data from the original R, G, B data.

4. The gamma adjustment circuit of claim 3, wherein the control circuit searches for gamma correction values corresponding to the at least two kinds of color data from the original R, G, B data requiring adjustment in the at least one LUT according to the corresponding address signals and directly outputs the at least two kinds of color data from the original R, G, B data according to the corresponding output signals.

5. The gamma adjustment circuit of claim 1, further comprising a processing circuit, wherein the processing circuit receives the original R, G, B data requiring adjustment and the gamma correction values corresponding to the original R, G, B data from the control circuit, and processes the original R, G, B data and the gamma correction values to obtain adjusted R, G, B data.

6. The gamma adjustment circuit of claim 5, wherein the processing circuit obtains the adjusted R, G, B data by adding the corresponding gamma correction values to the original R, G, B data.

7. The gamma adjustment circuit of claim 5, further comprising an output circuit, wherein the output circuit receives and outputs any one the adjusted R, G, B data from the processing circuit or any one of the original R, G, B data from the control circuit.

8. The gamma adjustment circuit of claim 7, wherein the determination circuit comprises at least two comparison circuit and at least two address generating circuit corresponding to the at least two kinds of color data from the R, G, B data, each comparison circuit receiving one original color data and determining gray scale of the original color data whether in one predetermined range corresponding to the original color data, and a corresponding address generating circuit generating an address signal when the gray scale of the original color data is in one predetermined range.

9. The gamma adjustment circuit of claim 8, wherein the control circuit comprises three control units respectively corresponding to the R, G, B data.

10. The gamma adjustment circuit of claim 9, wherein the process circuit comprises three adder units respectively corresponding to the R, G, B data.

11. The gamma adjustment circuit of claim 10, wherein the output circuit comprises three output units respectively corresponding to the R, G, B data.

12. A method for adjusting red, green, blue (R, G, B) data of an image signal by a gamma adjustment circuit, comprising:
providing at least one look up table (LUT) to store gamma correction values;
determining whether at least two kinds of color data from the R, G, B data requires adjustment;
searching for gamma correction values corresponding to the at least two kinds of color data from the R, G, B data requiring adjustment in the at least one LUT; and
outputting the at least two kinds of color data from the R, G, B data and the gamma correction values corresponding to the at least two kinds of color data from the R, G, B data requiring adjustment.

13. The method of claim 12, wherein determining whether the at least two kinds of color data from the R, G, B data requiring adjustment comprises determining whether gray scales of the at least two kinds of color data from the R, G, B data are in corresponding predetermined ranges in the at least one LUT, each predetermined range corresponding to one color data of the at least two kinds of color data from the R, G, B data, if gray scale of one color data is in the corresponding predetermined range, searching for gamma correction value corresponding to the color data requiring adjustment in the at least one LUT, if the gray scale of one color data is out of the corresponding predetermined range, directly outputting the color data.

14. The method of claim 13, wherein after searching for gamma correction value corresponding to the color data requiring adjustment in the at least one LUT, adjusting the color data according to the color data and the gamma correction value corresponding to the color data, and generating adjusted color data.

15. The method of claim 14, wherein adjusting the color data comprises adding the corresponding gamma correction value to the color data.

16. A display device, comprising:
a gamma adjustment circuit to receive and adjust red, green, blue (R, G, B) data of an image signal and output adjusted R, G, B data;
a data driving circuit to receive the adjusted R, G, B data and generate display driving signals according to the adjusted R, G, B data; and
a display panel to display the image according to the display driving signals;
wherein the gamma adjustment circuit comprises at least one look up table (LUT) to store gamma correction values, a determination circuit to determine whether the R, G, B data requires adjustment, and a control circuit to search for gamma correction values corresponding to the R, G, B data requiring adjustment in the at least one LUT and outputting the R, G, B data and the gamma correction values corresponding to the R, G, B data requiring adjustment.

17. The display device of claim 16, wherein the at least one LUT stores the gamma correction values corresponding to part of gray scales of at least two kinds of color data from the R, G, B data respectively in predetermined ranges, each predetermined range corresponding to one color data.

18. The display device of claim 17, wherein the determination circuit receives original R, G, B data and determines whether gray scales of the original R, G, B data are in the predetermined ranges, when the gray scales of the original R, G, B data are in the predetermined ranges, the original R, G, B data requiring adjustment, and the determination circuit outputting address signals to the control circuit, and when the gray scales of the original R, G, B data are out of the predetermined ranges, the determination circuit outputting an output signal to the control circuit to output the original R, G, B data.

19. The display device of claim 18, wherein the control circuit searches for gamma correction values corresponding to the original R, G, B data requiring adjustment in the at least one LUT according to the address signals and directly outputs the original R, G, B data according to the output signal.

20. The display device of claim 18, wherein the gamma adjustment circuit further comprises a processing circuit, the processing circuit receiving the original R, G, B data requiring adjustment and the gamma correction values corresponding to the original R, G, B data from the control circuit, and processing the original R, G, B data and the gamma correction values to obtain adjusted R, G, B data.
